(19) United States
(12) Patent Application Publication
(10) Pub. No.: US 2006/0203619 A1
(43) Pub. Date: Sep. 14, 2006

(54) Time display apparatus

(76) Inventor: David Wigley, LEICESTER (GB)

Correspondence Address: EGBERT LAW OFFICES, 412 MAIN STREET, 7TH FLOOR, HOUSTON, TX, 77002, US

(21) Appl. No.: 10/543,024

(22) PCT Filed: Dec. 30, 2003
(86) PCT No.: PCT/GB03/05695

§ 371 Date: Mar. 24, 2006

(30) Foreign Application Priority Data
Jan. 25, 2003 (GB) 0301797.7

(51) Int. Cl. G04B 19/00; G04C 17/00

(52) U.S. Cl. 368/223

(57) ABSTRACT

A time display apparatus includes a display unit and a control unit, the display unit being provided with an indicator portion of variable area and the control unit being operative to alter the area of the indicator portion in accordance with a first unit of time to be displayed. An additional control unit is operative to alter the visual appearance of the indicator portion, without altering the area of the indicator portion, in accordance with a second unit of time to be displayed, wherein the first unit of time is a minute, and the second unit of time is an hour.

### DESCRIPTION OF INVENTION

The present invention relates to apparatus for displaying the time.

Conventionally, apparatus for displaying the time are either analogue, in which case they include two hands which rotate around a central pivot, one hand representing hours and the other minutes, or digital, in which case they include a display showing the hours and minutes in a numerical form.

The analogue display has an advantage that users become familiar with the relationship between the position of the hands and the time, and can gain a indication of the time simply by glancing at the hands without having to study in detail the numbers on the display to which the hands are pointing.

For a conventional digital display, it is more difficult for a user to determine the time by glancing at the display. The user must study the display in sufficient depth to read both the number of hours and minutes in order to determine the time.

Apparatus for displaying the time are known, for example from GB2275353A, which include two linear scales, one representing hours and the other representing minutes, and two indicator means, one indicating the appropriate number on the hours scale and the other indicating the appropriate number of minutes on the minute scale. Such a display is, however, relatively complex, and it is difficult for a user easily to determine the time simply by glancing at the display.

According to a first aspect of the invention I provide a time display apparatus including a display unit and a control unit, the display unit being provided with an indicator portion of variable area and the control unit being operative to alter the area of the indicator portion in accordance with a first unit of time to be displayed, the or an additional control unit being operative to alter the visual appearance of the indicator portion, without altering the area of the indicator portion, in accordance with a second unit of time to be displayed wherein the first unit of time is a minute, and the second unit of time is an hour.

Thus a user may at a quick glance, determine the time from the size and appearance of the indicator portion. Moreover, as the indicator portion may be any shape, there is no restriction on the general shape of the display unit; and if the time is displayed using the twelve hour clock, the user need only remember what hour is represented by each of twelve visual appearances of the indicator portion.

Preferably the display unit includes a colour display, and the control unit is operative to alter the colour of the indicator portion in accordance with the second unit of time to be displayed. Alternatively or additionally, the indicator portion may be patterned, and the control unit may be operative to alter the pattern of the indicator portion in accordance with the second unit of time to be displayed.

The indicator portion may have the shape of a generally rectangular bar, the control unit being operative to alter the length of the bar in accordance with the first unit of time to be displayed.

Alternatively, the indicator portion may have the shape of a segment of an annulus, the control unit being operative to alter the circumferential extent of the indicator portion in accordance with the first unit of time to be displayed.

Alternatively, the indicator portion may have the shape of a segment of a circle, the control unit being operative to alter the angle subtended by the segment in accordance with the first unit of time to be displayed.

Preferably the control unit is operative to increase the area of the indicator portion as the value of the first unit of time to be displayed increases.

The display unit may include a liquid crystal display, part of which forms the indicator portion.

According to a second aspect of the invention, I provide a timepiece including a display unit and a control unit, the display unit being provided with an indicator portion of variable area and the control unit being operative to alter the area of the indicator portion in accordance with a first unit of time to be displayed and, the or an additional control unit being operative to alter the visual appearance of the indicator portion, without altering the area of the indicator portion, in accordance with a second unit of time to be displayed.

The timepiece may be a clock or a watch.

Specific and non-limiting embodiments of the invention will now be described, by way of example only, with reference to and/or as shown in the accompanying drawings of which,

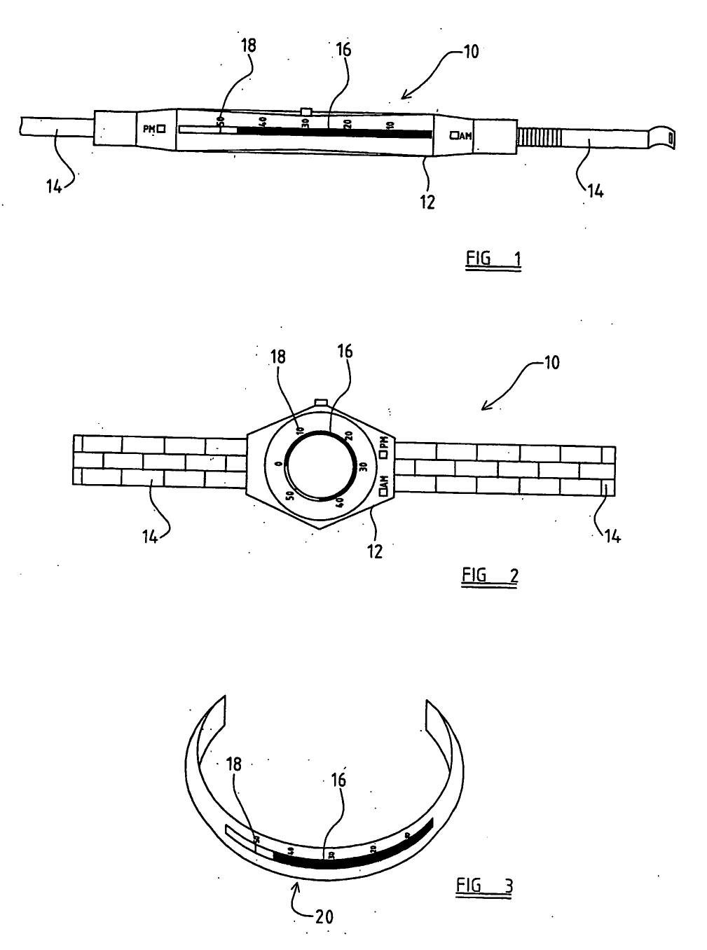

FIG. 1 is an illustration of a watch according the second aspect of the invention, and

FIG. 2 is an illustration of a second embodiment of a watch according to the second aspect of the invention.

FIG. 3 is an illustration of a bracelet incorporating a time display apparatus according to the first aspect of the invention.

Referring to FIG. 1, there is shown a watch 10 including a display unit 12, an electronic control unit (not shown) and a conventional wrist strap 14, the display unit 12 including a colour liquid crystal display on which is displayed an indicator portion 16 of variable area.

It should be understood that the control unit may include a plurality of components which interact to control what is displayed on the display unit 12, and the components need not be physically joined to form a single physical unit. Similarly, more than one control unit may be provided.

The indicator portion 16 consists of a portion of the liquid crystal display coloured with a pre-determined colour. There is sufficient contrast between the colour of the indicator portion 16 and the liquid crystal display background for a user readily to distinguish the indicator portion 16 from the background.

The control unit includes a conventional electronic time-keeping system and is programmed to alter the area of the indicator portion 16 in accordance with a first unit of the time to be displayed, in this case in accordance with the number of minutes of the time to be displayed.

In this example, the control unit varies the area of the indicator portion 16 by varying the number of adjacent segments of the liquid crystal display coloured with a pre-determined colour using conventional LCD technology. These segments of the liquid crystal display are generally rectangular and are arranged along a generally straight line such that the indicator portion 16 has the form of a generally rectangular bar, the length of which is variable. The control unit is programmed to increase the number of minute segments forming the indicator portion 16 by one every minute, and thus the number of coloured segments forming the indicator portion 16 corresponds to the number of minutes in the displayed time. Thus, if the indicator portion comprises fifteen coloured segments, the display unit 12 is displaying a time of fifteen minutes past the hour, for example.

A minute scale 18 is marked on the display unit 12 to assist a user in identifying exactly how many minutes are represented by the indicator portion length at that time. In this example, the scale 18 gives the number of minutes at ten minute intervals.

In this example, the control unit is also operative to alter the colour of the indicator portion 16 in accordance with a second unit of the time to be displayed. This could, of course, be performed by a second control unit. In this example, the hours of the twelve hour clock are each represented by a distinct colour. For example, one o'clock may be represented by a red indicator portion 16, two o'clock by an orange indicator portion 16, three o'clock by a yellow indicator portion 16 etc.

Thus a user may determine the time displayed from the colour and length of the indicator portion 16.

For example, an indicator portion 16 comprising twenty orange segments of liquid crystal display represents a time of twenty minutes past two.

Preferably when the time displayed is on the hour exactly, the indicator portion 16 includes sixty coloured segments, because representing a time of zero minutes past an hour using a indicator portion 16 comprising zero coloured segments would leave the user unable to identify the hour. Preferably, the control unit is programmed to change the colour of the indicator portion 16 to correspond to the hour just started rather than the hour just elapsed, thus the colour of the indicator portion 16 changes when the number of segments forming the indicator portion 16 increases from fifty nine to sixty.

Alternatively, the control unit may be programmed to change the colour of the indicator portion 16 when the number of segments forming the indicator portion 16 decreases from sixty to one, in which case it would be necessary for the user to remember that an indicator portion 16 comprising sixty orange segments represents a time of three o'clock (sixty minutes past two) rather than two o'clock.

When the time according to the twelve hour clock is displayed, preferably the control unit is programmed such that the display unit 12 also displays an indication as to whether the time is am or pm. In this example, the display unit 12 is provided with two indicator lights 22, 24 which are labelled AM and PM respectively, and the control unit is programmed to activate the light appropriate to the time of day. Alternatively, the letters AM or PM may be displayed on the LCD screen, or the display unit may include a single LED which is lit up when the time is am or alternatively when the time is pm.

Alternatively, the time could be displayed using the twenty four hour clock, in which case, it would be necessary for twenty four colours to be chosen to represent each hour. In this case, it would not be necessary to provide an am/pm indicator.

Once a user has become accustomed to which colour corresponds to which hour, and is familiar with the length range of the indicator portion 16, the user will be able to determine the time at a glance, as most users can with a conventional analogue watch. Unlike with a conventional analogue watch, however, the configuration of the display unit is not restricted to a generally circular shape, as illustrated by the above example, thus a display unit according to the invention offers more flexibility as to where and how it may be used.

For example, a time display apparatus according to the embodiment of the invention described above may be incorporated in a computer, the indicator portion being displayed on a visual display unit (VDU), connected to the computer. The VDU may be a conventional computer monitor or may include a liquid crystal display. As the indicator portion is generally rectangular and increases in length as time progresses, the indicator portion may be displayed along the top or bottom or up the sides of the VDU screen. Thus a user may readily obtain an indication of the time whilst working on the computer at a glance, or even from the corner of his eye without having to take his eyes off his work.

Alternatively, the indicator portion 16 may be incorporated in a head-up display, or displayed on clothing or jewellery such as a bangle or bracelet 20, as illustrated in FIG. 3.

A further embodiment of the invention is shown in FIG. 2, which also shows a watch 10, including a display unit 12, a control unit incorporated behind the display unit 12, and a conventional wrist strap 14. As in the previous example, the display unit 12 is a liquid crystal display which displays a coloured indicator portion 16 of variable area.

In this example, the segments of the liquid crystal display that make up the indicator portion 16 are arranged around the circumference of a circle, such that the indicator portion 16 has the form of a segment of an annulus whose circumferential extent increases as the number of minutes in the time to be displayed increases. The number of coloured segments making up the indicator portion 16 corresponds to the number of minutes in the time to be displayed, and the dimensions of the segments are such that sixty coloured segments form a complete circle.

A generally circular scale 18 is provided, and other than the difference in the configuration of the indicator portion 16, this embodiment of time display apparatus operates in exactly the same manner as the previous embodiment, the colour of the indicator portion 16 changing to indicate the hour of the time to be displayed.

The shape of the indicator portion 16 is not, however, restricted to those described above. The indicator portion 16 may, for example have the form of a segment of a circle, the control unit being programmed to increase the angle subtended by the segment with the number of minutes to be displayed until it becomes a full circle at sixty minutes, or have any other shape, the area of which varies according to the number of minutes of the time to be displayed.

Instead of representing the hour by means of the colour of the indicator portion 16, the hour may be represented by means of a pattern of the indicator portion 16. For example, the indicator portion may be patterned, such as with cross-hatching or an array of spots, and each hour of the time to be displayed corresponds to a different pattern of the indicator portion 16. Thus, the display unit need not be a colour display, and the display unit need only incorporate a monochrome LCD, for example.

Alternatively, the hour may be represented by the brightness of the indicator portion 16.

If the display unit is sufficiently large, the segments which form the indicator portion 16 may be subdivided into smaller sub-portions each of which represent one second or ten seconds. The control unit may be programmed to add a new coloured sub-portion every one or ten seconds as appropriate, and thus the area of the indicator portion 16 may be used to give an indication of seconds in addition to minutes, and scale 18 may be modified accordingly.

It is likely, however, that the one minute segments forming the indicator portion 16 would be too small to be divided into one or ten second sub-portions which enable the user readily to determine the number of seconds. In this case, it would be possible to provide a further indicator portion, the area of which varies according to the number of seconds of the time to be displayed. Such a second indicator portion would operate in the same way as the minute indicator portion 16, and the control unit would be programmed to increase the number of one or ten second segments in the second indicator portion by one every one second or every ten seconds respectively. The control unit may be programmed to alter the visual appearance (colour, pattern etc.) of the second indicator portion along with the visual appearance of the minute indicator portion according to the hour of the time to be displayed. Alternatively the visual appearance of the second indicator portion may be kept constant.

Moreover, although in the examples give above, the control unit is an electronic control unit, any other appropriate form of control unit capable of varying the area and visual appearance of the indicator portion in accordance with the time to be displayed may be used.

In the present specification “comprises” means “includes or consists of” and “comprising” means “including or consisting of”.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A time display apparatus including a display unit and a control unit, the display unit being provided with an indicator portion of variable area and the control unit being operative to alter the area of the indicator portion in accordance with a first unit of time to be displayed, the or an additional control unit being operative to alter the visual appearance of the indicator portion, without altering the area of the indicator portion, in accordance with a second unit of time to be displayed, wherein the first unit of time is a minute, and the second unit of time is an hour.

2. A time display apparatus according to claim 1 wherein the display unit includes a colour display, and the control unit is operative to alter the colour of the indicator portion in accordance with the second unit of time to be displayed.

3. A time display apparatus according to any preceding claim wherein the indicator portion is patterned, and the control unit is operative to alter the pattern of the indicator portion in accordance with the second unit of time to be displayed.

4. A time display apparatus according to any preceding claim wherein the indicator portion has the shape of a generally rectangular bar, the control unit being operative to alter the length of the bar in accordance with the first unit of time to be displayed.

5. A time display apparatus according to any one of claims 1 to 3 wherein the indicator portion has the shape of a segment of an annulus, the control unit being operative to alter the circumferential extent of the indicator portion in accordance with the first unit of time to be displayed.

6. A time display apparatus according to any one of claims 1 to 3 wherein the indicator portion has the shape of a segment of a circle, the control unit being operative to alter the angle subtended by the segment in accordance with the first unit of time to be displayed.

7. A time display apparatus according to any preceding claims wherein the control unit is operative to increase the area of the indicator portion as the value of the first unit of time to be displayed increases.

8. A time display apparatus according to any preceding claim wherein the display unit includes a liquid crystal display, part of which forms the indicator portion.

9. A timepiece including a display unit and a control unit, the display unit being provided with an indicator portion of variable area and the control unit being operative to alter the area of the indicator portion in accordance with a first unit of time to be displayed and, the or an additional control unit being operative to alter the visual appearance of the indicator portion, without altering the area of the indicator portion, in accordance with a second unit of time to be displayed.

10. A time display apparatus substantially as hereinbefore described with reference to and/or as shown in the accompanying drawings.

11. A timepiece substantially as hereinbefore described with reference to and/or as shown in the accompanying drawings.

12. Any novel feature or novel combination of features as hereinbefore described with reference to and/or as shown in the accompanying drawings.
